(19) United States
(12) Patent Application Publication
(10) Pub. No.: US 2023/0035417 A1
(43) Pub. Date: Feb. 2, 2023

(54) ANTENNA WITH AN OPEN SLOT AND A CLOSED SLOT

(71) Applicant: Hewlett-Packard Development Company, L.P., Spring, TX (US)

(72) Inventor: Kuan-Jung Hung, Taipei City (TW)

(73) Assignee: Hewlett-Packard Development Company, L.P., Spring, TX (US)

(21) Appl. No.: 17/789,604

(22) PCT Filed: Jan. 24, 2020
(86) PCT No.: PCT/US2020/015027

§ 371 Date: Jun. 28, 2022

(51) Int. Cl. H01Q 5/307; H01Q 1/22; H01Q 1/38; H01Q 13/10; H01Q 21/28

(52) U.S. Cl. CPC H01Q 5/307; H01Q 1/2291; H01Q 1/38; H01Q 13/106; H01Q 21/28

(57) ABSTRACT

Examples of antennas to reduce specific absorption rate (SAR) are described herein. In some examples, an antenna may include a metal structure with an open slot and a closed slot. A first radiator trace may be positioned to overlap a portion of the open slot. A second radiator trace may be positioned to overlap a portion of the closed slot. A matching network may pass a low frequency band to the first radiator trace and may pass a high frequency band to the second radiator trace.

### BACKGROUND

In wireless communication, antennas may send and receive wireless signals. Some antenna devices may use multiple antennas to enhance wireless communication. For example, an antenna device may include a first antenna element to communicate in a first frequency band and a second antenna element to communicate in a second frequency band.

### BRIEF DESCRIPTION OF THE DRAWINGS

Various examples will be described below by referring to the following figures.

FIG. 1 is an example of an antenna to reduce specific absorption rate (SAR);

FIG. 2 is another example of an antenna to reduce SAR;

FIG. 3 is a first example of an antenna to reduce SAR with two matching networks;

FIG. 4 is a second example of an antenna to reduce SAR with two matching networks;

FIG. 5 is a third example of an antenna to reduce SAR with two matching networks;

FIG. 6 is a fourth example of an antenna to reduce SAR with two matching networks;

FIG. 7 is an example of components for a metal structure used in an antenna to reduce SAR;

FIG. 8 is another example of an antenna for reducing SAR; and

FIG. 9 is a flow diagram illustrating a method for forming an antenna to reduce SAR.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations in accordance with the description; however, the description is not limited to the examples and/or implementations provided in the drawings.

### DETAILED DESCRIPTION

Examples of antennas to reduce specific absorption rate (SAR) are described herein. For instance, example structures and methods for SAR reduction for slot antennas are described.

Specific absorption rate (SAR) is a measure of the rate at which energy is absorbed by the human body when exposed to a radio frequency (RF) electromagnetic field from a given source. For example, the antenna of a wireless communication device may generate an RF electromagnetic field. SAR may reflect the rate at which the RF energy generated by an antenna is absorbed by the human body.

The SAR value for a device may be regulated by various governmental agencies. For example, the Federal Communications Commission (FCC) sets limits for allowable maximum SAR values for a device. Therefore, some devices (e.g., wireless communication devices) may be tested for SAR before being certified for sale to the public. As such, the SAR value of an antenna may be minimized.

In some examples, SAR may be reduced by reducing the RF energy emitted by an antenna. However, this approach may result in reduced performance for the antenna. For example, reducing the RF energy emitted by an antenna may reduce the distance that an RF signal may travel and be correctly received.

In other examples, SAR may be reduced by using a lower frequency band for a given antenna. As used herein, a “frequency band” includes a range of radio frequencies. A frequency band may also be referred to as a radio band. A frequency band includes a contiguous section of the radio spectrum frequencies. For example, the Institute of Electrical and Electronics Engineers (IEEE) defines certain frequency bands. One example of a frequency band is the S-band that contains the 2.4 to 2.483 gigahertz (GHz) industrial, scientific and medical (ISM) band used by cellphones, Bluetooth devices, wireless networking (Wi-Fi), etc. Another example of a frequency band is the C-band that includes frequencies ranging from 4.0 to 8.0 GHz. In an example, C-band frequencies of the 5 GHz band (e.g., 5.15 to 5.35 GHz, 5.47 to 5.725 GHz, or 5.725 to 5.875 GHz, depending on the regulatory region) may be used for IEEE 802.11a Wi-Fi wireless computer networks.

In yet other examples, SAR may be reduced through the structure of the antenna. For example, an antenna may include a slot structure forming a slot antenna. As used herein a “slot” is a cavity (e.g., hole, channel, depression, etc.) formed in a metal surface. When the metal plate is driven as an antenna by a driving frequency, the slot radiates electromagnetic waves in a manner similar to a dipole antenna.

A closed slot antenna may emit less concentrated RF energy than an open slot. As used herein, a closed slot antenna is a slot antenna having a slot that is enclosed on each side. In other words, the slot may be closed off by the metal structure forming the slot. An open slot antenna is a slot antenna having an open side. For example, one side of the metal structure forming the slot may be open. More RF energy may be emitted at the opening of an open slot antenna that from a closed slot antenna.

In some examples, SAR may be reduced but performance of the antenna may be maintained by using both a slot antenna and a closed slot antenna. For example, a slot antenna and a closed slot antenna may be integrated by using a matching network. In some examples, the matching network may be connected to radiator traces. It should be noted that the components of the matching network may not have a direct contact to the metal structure forming the open slot and the closed slot. In some examples, the open slot may be used for a low frequency band (e.g., 2.4 GHz band) and the closed slot may be used for a high frequency band (e.g., 5 GHz band) for reducing SAR at higher frequencies.

In some examples, a single matching network may be used. For example, a matching network may be a low pass filter for passing low frequency band (e.g., 2.4 GHz band) to the open slot while blocking the high frequency band (e.g., 5 GHz band) from the open slot.

In other examples, two matching networks may be used. A first matching network may be a low pass filter for passing the low frequency band (e.g., 2.4 GHz band) to the open slot. The second matching network may be a high pass filter for passing a high frequency band (e.g., 5 GHz band) to the closed slot.

The length of the slots may be optimized for the wavelengths of their associated frequency band. In some examples, the open slot may be one quarter (¼) as long as the wavelength of the low frequency band. The length of the closed slot may be half (½) as long as the wavelength of a high frequency band. Other examples of antennas to reduce specific absorption rate (SAR) are described herein.

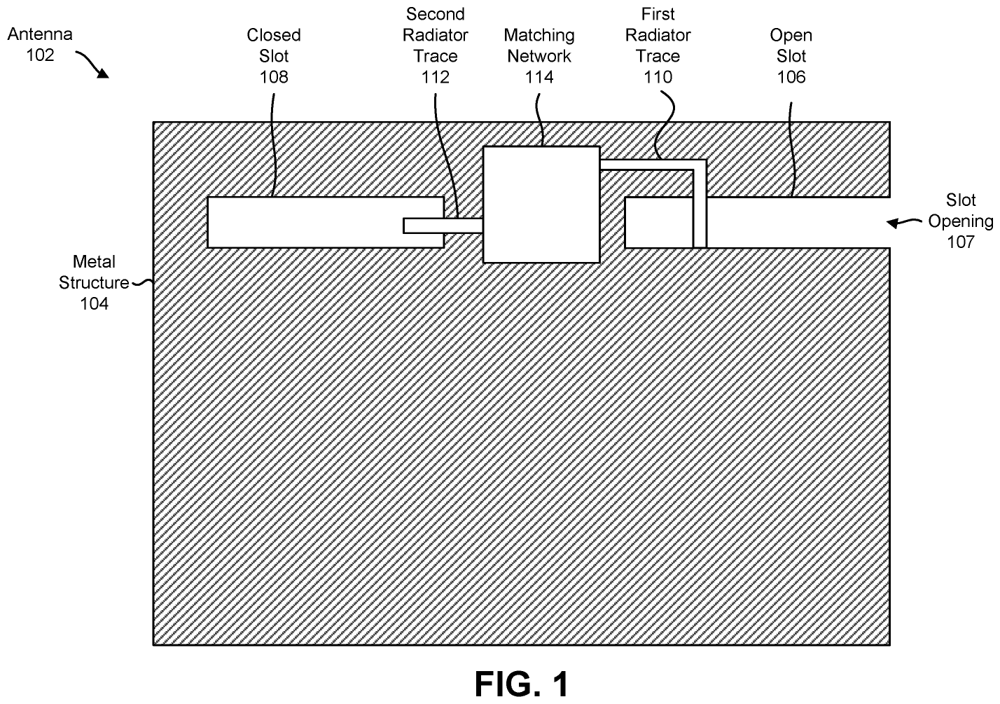

FIG. 1 is an example of an antenna 102 to reduce specific absorption rate (SAR). In some examples, the antenna 102 may be used in a wireless communication device (e.g., cellphone, laptop computer, desktop computer, tablet computer, gaming controller, gaming console, etc.).

The antenna 102 may include an open slot 106 and a closed slot 108 formed in a metal structure 104. In some examples, the metal structure 104 may be a metal plate. The metal structure 104 may be a cover for a wireless communication device. For example, the metal structure 104 may be included in a back cover of a wireless communication device.

In some examples, the open slot 106 may be an opening through the metal structure 104. For example, the open slot 106 may be a channel, hole or other shape that forms an opening in the metal structure 104. The open slot 106 may have a slot opening 107 in one side of the metal structure 104. In the example of FIG. 1, the right side of the open slot 106 is the slot opening 107. In some examples, the open slot 106 may have a rectangular profile. However, other shapes (e.g., curved, oval, capsule, etc.) may be used to form the profile of the open slot 106.

In some examples, the closed slot 108 may be an opening in the metal structure 104 that is enclosed on all sides by the metal structure 104. In the example of FIG. 1, the closed slot 108 has a rectangular profile. However, other shapes (e.g., curved, oval, circular, capsule, etc.) may be used to form the profile of the closed slot 108.

In some examples, the open slot 106 and the closed slot 108 may be aligned along a single axis. In the example of FIG. 1, the open slot 106 and the closed slot 108 share a common longitudinal axis.

For an antenna with an open slot 106, the slot opening 107 is where the maximum electromagnetic field may occur. Therefore SAR may be greatest at the slot opening 107 of the open slot 106 due to the maximum electromagnetic field in this location. The SAR may also increase at the slot opening 107 as frequencies increase. Therefore, a higher frequency band may result in higher SAR at the slot opening 107 as compared to a low frequency band. For example, an open slot antenna supporting wireless local area network (WLAN) dual band 2.4 GHz and 5 GHz bands might have higher a SAR at the 5 GHz band than the 2.4 GHz band.

In one example, the antenna 102 may use the open slot 106 for a low frequency band (e.g., WLAN 2.4 GHz band) and the closed slot 108 for the high frequency band (e.g., WLAN 5 GHz band). With this approach for slot integration, the SAR associated with a high frequency band (e.g., WLAN 5 GHz band) may be mitigated as compared to dual-band open slot antennas that transmit on both the low and high frequency bands (e.g., 2.4 GHz and 5 GHz). However, using an open slot 106 for the low frequency band may improve antenna efficiency as compared to both frequency bands (e.g., 2.4 GHz and 5 GHz) being transmitted on the closed slot 108. In other words, the open slot 106 may be used to increase the efficiency for the low frequency band, while maintaining SAR within regulatory limits. The closed slot 108 may be used to reduce the SAR for the high frequency band.

In some examples, the antenna 102 may integrate the open slot 106 and the closed slot 108 together with a matching network 114. A first radiator trace 110 may be positioned to overlap a portion of the open slot 106. As used herein, a “radiator trace” is a conductive element (e.g., metal) that radiates for a given electromagnetic frequency. A radiator trace may radiate RF energy. A “radiator trace” may also be referred to as an “excitation radiator” or a “radiator.”

The first radiator trace 110 may form a certain type of antenna. For example, the first radiator trace 110 may form a planar inverted-F antenna (PIFA), a monopole antenna, a loop antenna, etc. In some examples, the first radiator trace 110 may include a parasitic element. A portion of the first radiator trace 110 may be located over the open slot 106. A signal provided to the first radiator trace 110 within the low frequency band may cause the open slot 106 to radiate electromagnetic waves within the low frequency band.

In some examples, the low frequency band passed to the first radiator trace 110 may include a WLAN band of approximately 2.4 gigahertz (GHz). However, other frequencies may be used for the low frequency band.

A second radiator trace 112 may be positioned to overlap a portion of the closed slot 108. The second radiator trace 112 may form a certain type of antenna. For example, the second radiator trace 112 may form a planar inverted-F antenna (PIFA), a monopole antenna, a loop antenna, etc. In some examples, the second radiator trace 112 may include a parasitic element. A portion of the second radiator trace 112 may be located over the closed slot 108. A signal provided to the second radiator trace 112 within the high frequency band may cause the closed slot 108 to radiate electromagnetic waves within the high frequency band.

In some examples, the high frequency band passed to the second radiator trace 112 may include a WLAN band of approximately 5 GHz. However, other frequencies may be used for the high frequency band.

A matching network 114 may pass the low frequency band to the first radiator trace 110. As used herein, a matching network performs impedance matching based on the frequency band that is to pass to a given radiator trace. Therefore, the matching network 114 may perform impedance matching for the first radiator trace 110 based on the low frequency band. The matching network 114 may allow the high frequency band to pass to the second radiator trace 112. For example, the matching network 114 may be coupled between the first radiator trace 110 and the second radiator trace 112. The matching network 114 may include inductive, resistive and/or capacitive components. The matching network 114 may act as a low pass filter to pass the low frequency band to the first radiator trace 110 while blocking the high frequency band from the first radiator trace 110. Therefore, the matching network 114 may be a frequency diplexer.

It should be noted that the components of the matching network 114 need not have conductive and/or direct contact to the top metal arm forming the open slot 106. Instead the components of the matching network 114 may be electrically connected to first radiator trace 110 and not the metal structure 104.

In some examples, a feeding line (not shown) for the antenna 102 may be coupled to the second radiator trace 112. For example, the feeding line may supply both the low frequency band and the high frequency band for the antenna 102.

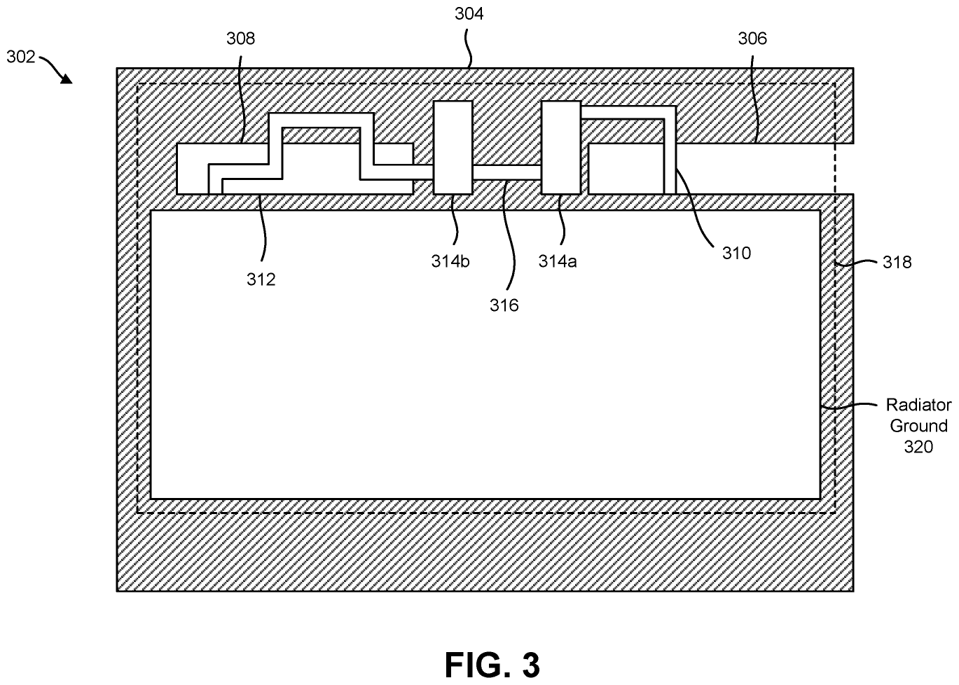

As described above, the matching network 114 may allow the low frequency band to pass to the first radiator trace 110 while blocking the high frequency band from the first radiator trace 110. In this example, both the low frequency band and the high frequency band may be transmitted on the second radiator trace 112. In other examples, a second matching network 114 may be used as a high pass filter that blocks the low frequency band from the second radiator trace 112. Examples of this approach are described in connection with FIGS. 3-6.

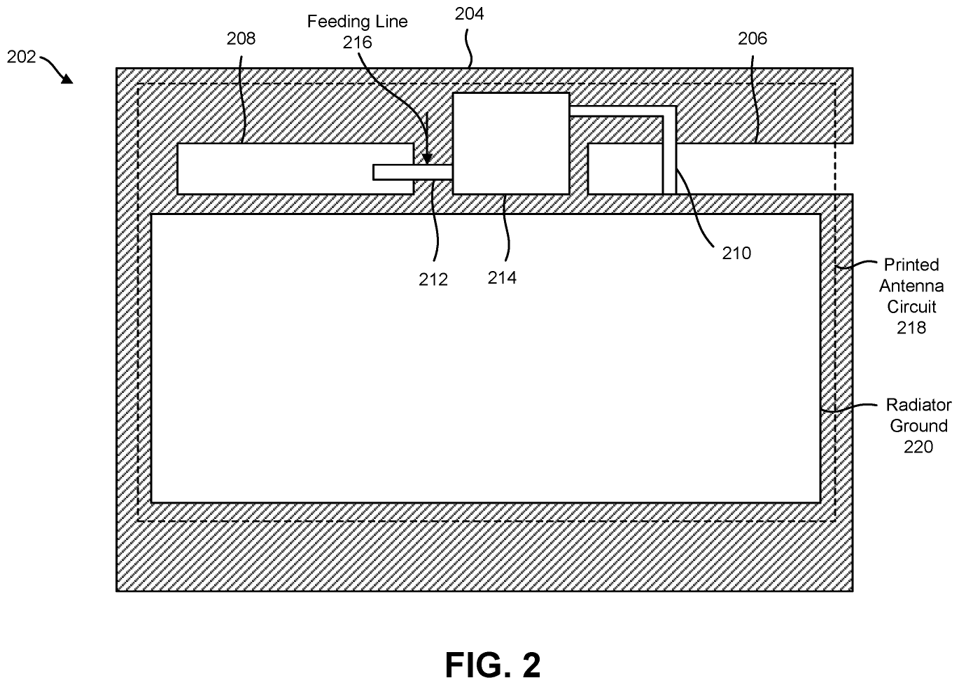

In some examples, the first radiator trace 110, the second radiator trace 112 and the matching network 114 may be included in a printed antenna circuit. For example, the printed antenna circuit may be a printed circuit board (PCB) or a flexible printed circuit (FPC). The printed antenna circuit may be attached (e.g., bonded) to the metal structure 104 in an assembled position. The first radiator trace 110 and the second radiator trace 112 may be located on the printed antenna circuit such that first radiator trace 110 is positioned to overlap a portion of the open slot 106 and the second radiator trace 112 is positioned to overlap a portion of the closed slot 108 when in the assembled position. An example of this approach is described in connection with FIG. 2.

FIG. 2 is another example of an antenna 202 to reduce SAR. In this example, a metal structure 204 may include an open slot 206 and a closed slot 208 as described in connection with FIG. 1.

A printed antenna circuit 218 may be attached to the metal structure 204. In some examples, the printed antenna circuit 218 may be a printed circuit board (PCB). In other examples, the printed antenna circuit 218 may be a flexible printed circuit (FPC).

In some examples, the printed antenna circuit 218 may be attached to the metal structure 204 with an adhesive. Therefore, in this approach, the printed antenna circuit 218 may be bonded to the metal structure 204. In other examples, the printed antenna circuit 218 may be attached to the metal structure 204 with mechanical fasteners (e.g., screws, snap-fittings, etc.). In yet other examples, other components in a wireless communication device may exert a force on the printed antenna circuit 218 such that printed antenna circuit 218 remains in a fixed position relative to the metal structure 204. The attached location of the printed antenna circuit 218 relative to the metal structure 204 is referred to herein as the “assembled position”

In some examples, the printed antenna circuit 218 may include a first radiator trace 210 positioned to overlap a portion of the open slot 206. For example, the first radiator trace 210 may be fabricated on the printed antenna circuit 218 such that when the printed antenna circuit 218 is in the assembled position, the first radiator trace 210 overlaps a portion of the open slot 206.

In some examples, the printed antenna circuit 218 may also include a second radiator trace 212 positioned to overlap a portion of the closed slot 208. For example, the second radiator trace 212 may be fabricated on the printed antenna circuit 218 such that when the printed antenna circuit 218 is in the assembled position, the second radiator trace 212 overlaps a portion of the closed slot 208.

The printed antenna circuit 218 may also include a matching network 214. In some examples, the matching network 214 may pass a low frequency band to the first radiator trace 210. The matching network 214 may pass a high frequency band to the second radiator trace 212.

In some examples, the printed antenna circuit 218 may also include a feeding line 216 for the antenna 202. The feeding line 216 may be coupled to the second radiator trace 212. For example, the feeding line 216 may provide both the low frequency band and the high frequency band for the antenna 202. The matching network 214 may allow the low frequency band to pass to the first radiator trace 210 while blocking the high frequency band from the first radiator trace 210. It should be noted that by placing the feeding line 216 on the second radiator trace 212, the SAR for the open slot 206 may be reduced because the energy associated with the high frequency band is blocked from the first radiator trace 210 of the open slot 206.

In this example, the printed antenna circuit 218 also includes a radiator ground 220. In some examples, the radiator ground 220 may be used to connect the printed antenna circuit 218 to the metal structure 204. For example, the radiator ground 220 may provide an electrical connection between the printed antenna circuit 218 and the metal structure 204.

FIG. 3 is a first example of an antenna 302 to reduce SAR with two matching networks. In this example, a metal structure 304 may include an open slot 306 and a closed slot 308 as described in connection with FIG. 1.

The antenna 302 also includes a printed antenna circuit 318. In some examples, the printed antenna circuit 318 may be a printed circuit board (PCB). In other examples, the printed antenna circuit 318 may be a flexible printed circuit (FPC). The printed antenna circuit 318 may be attached to the metal structure 304.

The printed antenna circuit 318 may include a first radiator trace 310. In this example, a first matching network 314a may be coupled to the first radiator trace 310. In some examples, the first matching network 314 may include components (e.g., resistive, inductive and/or capacitive components) to pass a low frequency band to the first radiator trace 310.

The printed antenna circuit 318 may also include a second radiator trace 312. In this example, a second matching network 314b may be coupled to the second radiator trace 312. In some examples, the second matching network 314b may include components (e.g., resistive, inductive and/or capacitive components) to pass a high frequency band to the second radiator trace 312.

The printed antenna circuit 318 may also include a feeding line 316 for the antenna 302. In this example, the feeding line 316 may be coupled to the first matching network 314a and the second matching network 314b. The low frequency band and the high frequency band may be provided to the feeding line 316. The first matching network 314a may allow the low frequency band to pass to the first radiator trace 310 while blocking the high frequency band from the first radiator trace 310. The second matching network 314b may allow the high frequency band to pass to the second radiator trace 312 while blocking the low frequency band from the second radiator trace 312.

In this example, the printed antenna circuit 318 also includes a radiator ground 320. In some examples, the radiator ground 320 may be used to connect the printed antenna circuit 318 to the metal structure 304.

In this example, the second radiator trace 312 is a loop antenna. Also in this example, the first matching network 314a and the second matching network 314b are located in a bridge portion of the metal structure 304 between the open slot 306 and the closed slot 308.

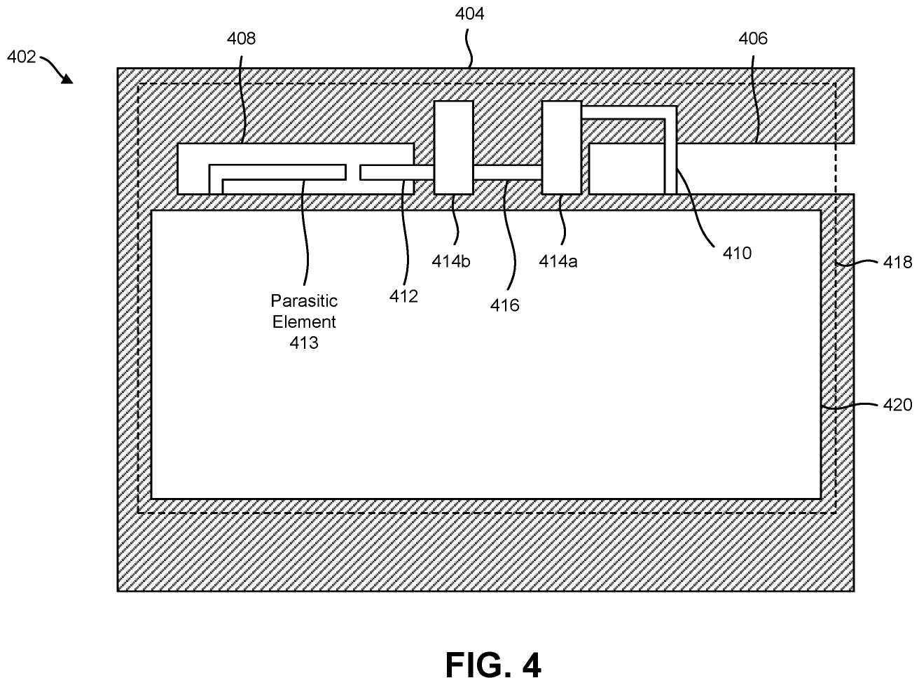

FIG. 4 is a second example of an antenna 402 to reduce SAR with two matching networks. In this example, a metal structure 404 may include an open slot 406 and a closed slot 408 as described in connection with FIG. 1.

The antenna 402 also includes a printed antenna circuit 418. The printed antenna circuit 418 may include a first radiator trace 410, a second radiator trace 412, a first matching network 414a, a second matching network 414b, a feeding line 416, and a radiator ground 420 as described in connection with FIG. 3. It should be noted that in this example, the second radiator trace 412 is a monopole antenna with a parasitic element 413.

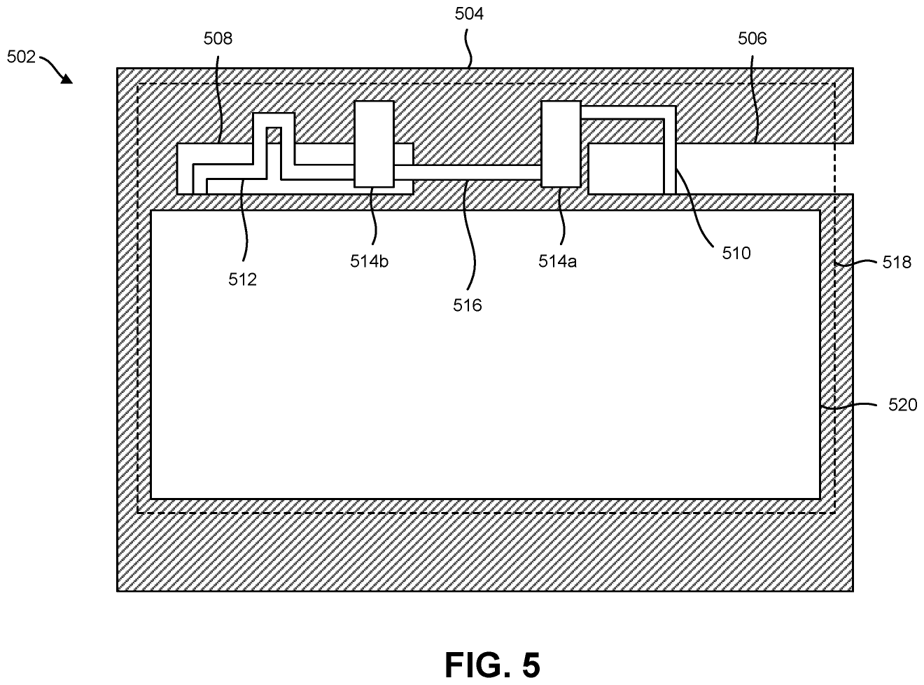

FIG. 5 is a third example of an antenna 502 to reduce SAR with two matching networks. In this example, a metal structure 504 may include an open slot 506 and a closed slot 508 as described in connection with FIG. 1.

The antenna 502 also includes a printed antenna circuit 518. The printed antenna circuit 518 may include a first radiator trace 510, a second radiator trace 512, a first matching network 514a, a second matching network 514b, a feeding line 516, and a radiator ground 520 as described in connection with FIG. 3.

It should be noted that in this example, the second radiator trace 512 is a loop antenna. Furthermore, in this example, the second matching network 514b is located over the closed slot 508.

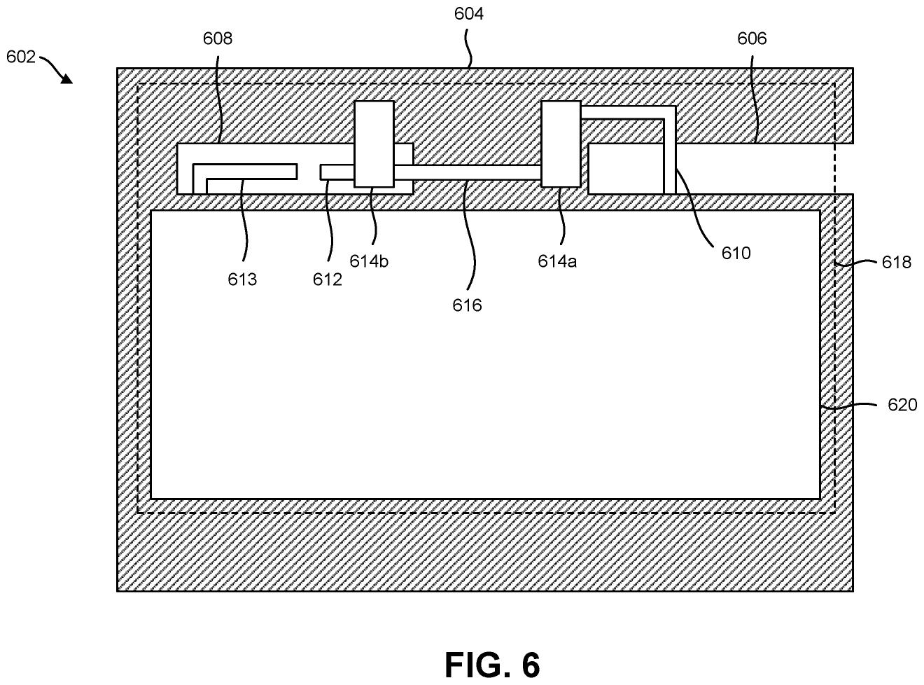

FIG. 6 is a fourth example of an antenna 602 to reduce SAR with two matching networks. In this example, a metal structure 604 may include an open slot 606 and a closed slot 608 as described in connection with FIG. 1.

The antenna 602 also includes a printed antenna circuit 618. The printed antenna circuit 618 may include a first radiator trace 610, a second radiator trace 612, a first matching network 614a, a second matching network 614b, a feeding line 616, and a radiator ground 620 as described in connection with FIG. 3.

It should be noted that in this example, the second radiator trace 612 is a monopole antenna with a parasitic element 613. Furthermore, in this example, the second matching network 614b is located over the closed slot 608.

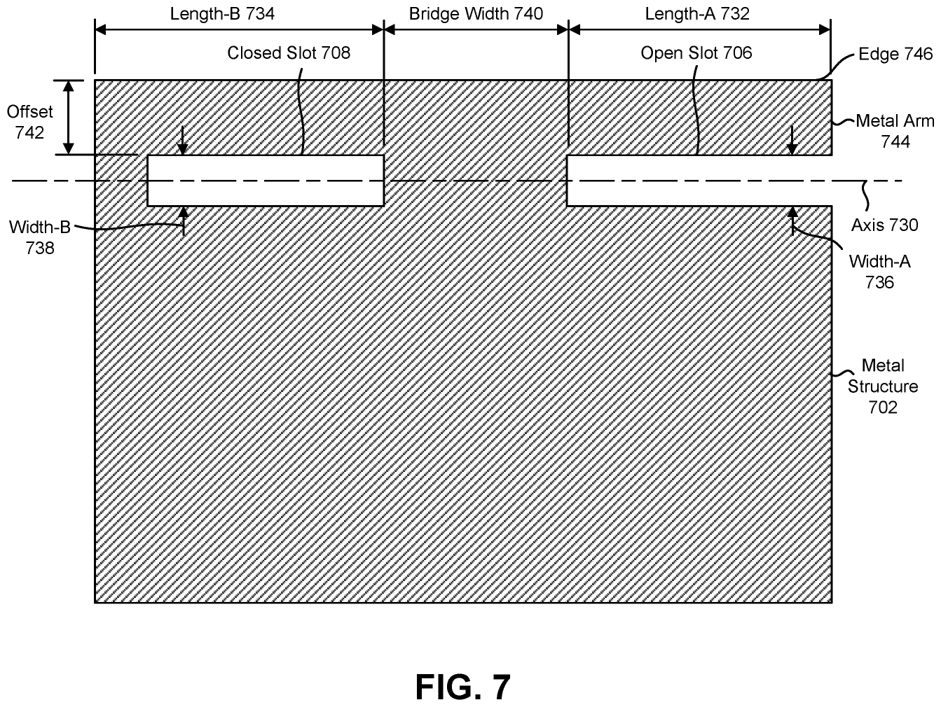

FIG. 7 is an example of components for a metal structure 702 used in an antenna to reduce SAR. In some examples, the metal structure 702 may be a metal plate.

In this example, the metal structure 702 includes an open slot 706 and a closed slot 708. The open slot 706 and the closed slot 708 may form openings in the metal structure 702.

In some examples, the open slot 706 and the closed slot 708 may be defined with a single axis 730. In other words, the open slot 706 and the closed slot 708 may share a longitudinal axis 730. Therefore, open slot 706 and the closed slot 708 may be primarily linear elements. It should be noted that in other examples, the open slot 706 and the closed slot 708 may have different axes.

The open slot 706 may have a length-A 732. In some examples, the length-A 732 for the open slot 706 may be approximately one quarter (¼) an effective wavelength for the low frequency band. Permittivity affects the speed of propagation of a wave through a medium and also its wavelength. The permittivity of a medium is most often given as a relative permittivity. The effective wavelength λ_{eff} is the dielectric medium loaded wavelength (ε_{eff}≥1) and it is always shorter than the free space wavelength λ₀, where the medium is air and the permittivity is 1. The relation is λ_{eff}=λ₀/√ε_{eff}. In an example, the length-A 732 may be approximately ¼ the 2.4 gigahertz (GHz) wavelength.

The open slot 706 may also have a width-A 736. In some examples, the width-A 736 may be between 1.5 millimeters (mm) and 3.0 mm. It should be noted that the width-A 736 may be determined to optimize appearance and performance of the antenna and performance of the antenna. A thinner width-A 736 may enhance the appearance of the antenna, but may reduce the antenna efficiency.

The closed slot 708 may have a length-B 734. In some examples, the length-B 734 for the closed slot 708 may be approximately one half an effective wavelength for the high frequency band. For example, the length-B 734 may be approximately ½ the 5 gigahertz (GHz) wavelength. The closed slot 708 may also have a width-B 738. The width-B 738 of the closed slot 708 may be the same as or different than the width-A 736 of the open slot 706. The width-B 738 may also optimize appearance and performance of the antenna.

The open slot 706 and the closed slot 708 may be separated by a bridge width 740. In some examples, the bridge width 740 may be selected to maximize the power transmitted at the open slot 706 while minimizing the SAR generated at the open slot 706.

An edge of the open slot 706 and the closed slot 708 may be located at an offset 742 from an edge 746 of the metal structure 702. The material of the metal structure 702 between the edge 746 of the metal structure 702 and the open slot 706 may be referred to as the metal arm 744.

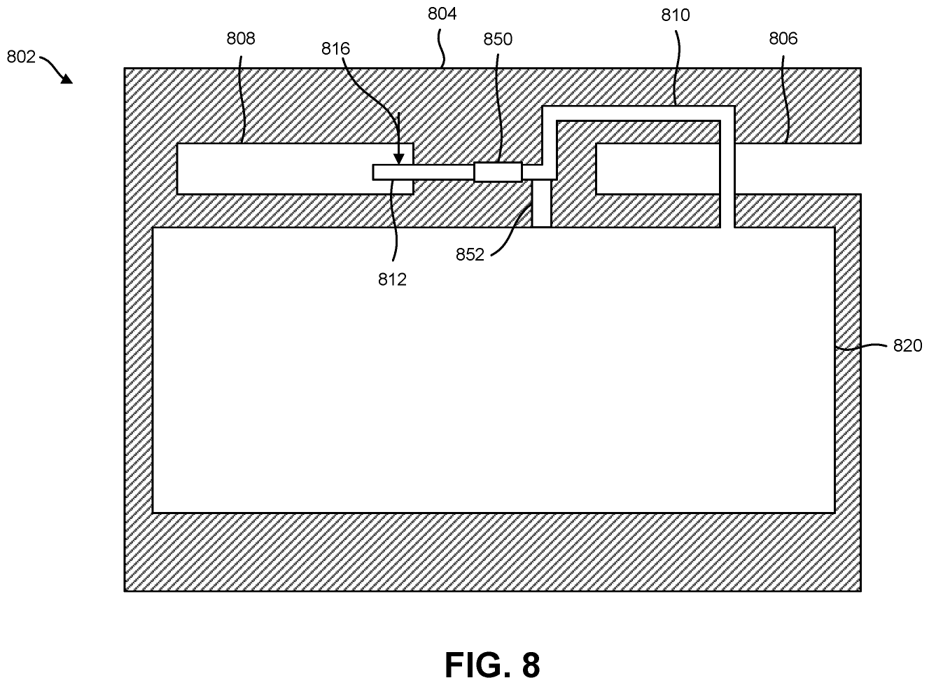

FIG. 8 is another example of an antenna 802 for reducing SAR. The metal structure 804 may include an open slot 806 and a closed slot 808.

In this example, the first radiator trace 810 forms a loop antenna to the radiator ground 820. The second radiator trace 812 forms a monopole antenna.

In this example, the length of the open slot 806 may be defined for a WLAN 2.4 GHz band. For instance, the length for the open slot 806 may be approximately one quarter the effective wavelength for the WLAN 2.4 GHz band.

The length of the closed slot 808 may be defined for the WLAN 5 GHz band. For instance, the length for the closed slot 808 may be approximately one half the effective wavelength for the WLAN 5 GHz band.

In this example, the feeding line 816 may be located within the area of the closed slot 808. In other words, the feeding line 816 may be coupled to the second radiator trace 812.

Components for a matching network may be added between the open slot 806 and the closed slot 808. For example, an inductive component 850 may be coupled in series with the second trace 812. A capacitive component 852 may be coupled to the first radiator trace 810 and the radiator ground 820.

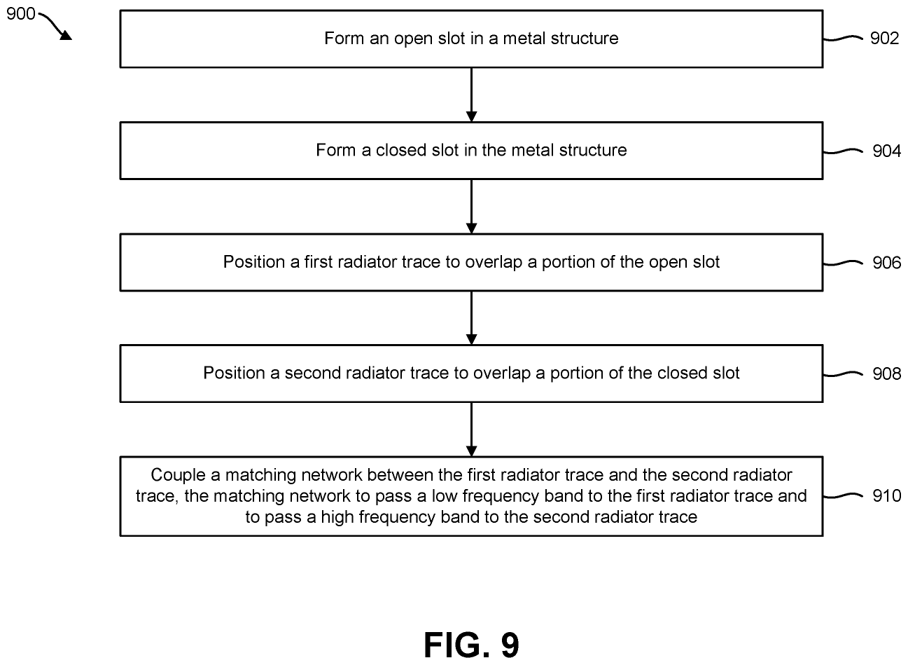

FIG. 9 is a flow diagram illustrating a method 900 for forming an antenna 102 to reduce SAR. An open slot 106 may be formed 902 in a metal structure 104. For example, the open slot 106 may be cut into the metal structure 104. In another example, the open slot 106 may be molded into the metal structure 104. In some examples, the length for the open slot 106 may be approximately one quarter an effective wavelength for a low frequency band (e.g., the WLAN 2.4 GHz band).

A closed slot 108 may be formed 904 in the metal structure 104. For example, the closed slot 108 may be cut into the metal structure 104. In another example, the closed slot 108 may be molded into the metal structure 104. In some examples, the length for the closed slot 108 may be approximately one half an effective wavelength for the high frequency band (e.g., WLAN 5 GHz band).

A first radiator trace 110 may be positioned 906 to overlap a portion of the open slot 106. A portion of the first radiator trace 110 may be located over the open slot 106. In some examples, the first radiator trace 110 may be fabricated on a printed antenna circuit 218. Examples of the printed antenna circuit 218 include a printed circuit board (PCB) or a flexible printed circuit (FPC). The first radiator trace 110 may be located on the printed antenna circuit 218 in a location such that first radiator trace 110 is positioned to overlap a portion of the open slot 106 when the printed antenna circuit 218 is in an assembled position.

A second radiator trace 112 may be positioned 908 to overlap a portion of the closed slot 108. In some examples, the second radiator trace 112 may be fabricated on the printed antenna circuit 218. The second radiator trace 112 may be located on the printed antenna circuit 218 in a location such that second radiator trace 112 is positioned to overlap a portion of the closed slot 108 when the printed antenna circuit 218 is in the assembled position.

A matching network 114 may be coupled 910 between the first radiator trace 110 and the second radiator trace 112. The matching network 114 may pass a low frequency band (e.g., the WLAN 2.4 GHz band) to the first radiator trace 110. The matching network 114 may allow a high frequency band (e.g., WLAN 5 GHz band) to pass to the second radiator trace 112. In some examples, the low frequency band and the high frequency band may be supplied to a feeding line coupled to the second radiator trace 112. In other examples, the low frequency band and the high frequency band may be supplied to a feeding line coupled between a first matching network and a second matching network. In this case, the first matching network may be coupled to the first radiator trace 110 and the second matching network may be coupled to the second radiator trace 112.

1. An antenna, comprising:
a metal structure comprising an open slot and a closed slot;
a first radiator trace positioned to overlap a portion of the open slot;
a second radiator trace positioned to overlap a portion of the closed slot; and
a matching network to pass a low frequency band to the first radiator trace and to pass a high frequency band to the second radiator trace.

2. The antenna of claim 1, wherein the matching network is coupled between the first radiator trace and the second radiator trace.

3. The antenna of claim 1, further comprising a feeding line for the antenna coupled to the second radiator trace.

4. The antenna of claim 1, wherein the low frequency band passed to the first radiator trace comprises a wireless local area network (WLAN) band of approximately 2.4 gigahertz (GHz).

5. The antenna of claim 1, wherein the high frequency band passed to the second radiator trace comprises a WLAN band of approximately 5 GHz.

6. An antenna comprising:
a metal structure comprising an open slot and a closed slot; and
a printed antenna circuit attached to the metal structure, the printed antenna circuit comprising:
a first radiator trace positioned to overlap a portion of the open slot;
a second radiator trace positioned to overlap a portion of the closed slot; and
a matching network to pass a low frequency band to the first radiator trace and to pass a high frequency band to the second radiator trace.

7. The antenna of claim 6, wherein the printed antenna circuit comprises a printed circuit board (PCB) or a flexible printed circuit (FPC).

8. The antenna of claim 6, wherein the metal structure is a cover for a mobile communication device.

9. The antenna of claim 6, wherein the matching network does not have conductive contact with the metal structure.

10. The antenna of claim 6, wherein the printed antenna circuit further comprises a second matching network to act as a high pass filter that blocks the low frequency band from the second radiator trace.

11. A method, comprising:
forming an open slot in a metal structure;
forming a closed slot in the metal structure;
positioning a first radiator trace to overlap a portion of the open slot;
positioning a second radiator trace to overlap a portion of the closed slot; and
coupling a matching network between the first radiator trace and the second radiator trace, the matching network to pass a low frequency band to the first radiator trace and to pass a high frequency band to the second radiator trace.

12. The method of claim 11, wherein the open slot and the closed slot are aligned along a single axis.

13. The method of claim 11, further comprising supplying the low frequency band and the high frequency band to a feeding line coupled to the second radiator trace.

14. The method of claim 11, wherein a length for the open slot is approximately one quarter an effective wavelength for the low frequency band.

15. The method of claim 11, wherein a length for the closed slot is approximately one half an effective wavelength for the high frequency band.
